(19) United States
(12) Patent Application Publication
(10) Pub. No.: US 2003/0014271 A1
(43) Pub. Date: Jan. 16, 2003

(54) Method and system to assist customers in getting lower usage rate

(76) Inventor: Ten-Lee Hwang, Taipei (TW)

Correspondence Address: POWELL, GOLDSTEIN, FRAZER & MURPHY LLP, P.O. BOX 97223, WASHINGTON, DC, 20090-7223, US

(21) Appl. No.: 09/930,766

(22) Filed: Aug. 16, 2001

(30) Foreign Application Priority Data
Jul. 16, 2001 (TW) 90117383

(51) Int. Cl. G06F 17/60

(52) U.S. Cl. 705/1

(57) ABSTRACT

A method and a system to assist customers to get lower communication usage rates are disclosed. The system utilizes a front-end control device and a central server to help customers choose the service operator offering lowest usage rate wherein the central server receives the dialing data from the front-end control device to calculate communication-cost. Thereafter, a code name is generated by the central server and transmitted to the front-end control device to update the number-mapping table thereof. When the customer makes a communication call, such as an international call, the front-end control device may automatically select the service operators providing a lowest communication-cost according the number-mapping table.

### FIELD OF THE INVENTION

The present invention generally relates to a method and system to provide communication usage information to customers, and more particularly, to a method and system to assist customers, consumers and enterprises alike, in getting lower communication usage rate by using a central server at a central location and front-end control devices at customer sites such that at least the customers are able to dynamically select one service operator that offers the best rates from caller perspectives.

### BACKGROUND OF THE INVENTION

Due to liberalization of the telecom industry, there are often more than one service operators offering the same telecom services for customers in a predefined geographical region. Because of competition, service operators offer different calling rates to customers even when the call is for exactly the same destination. For example, service operator A charges customers NT$ 0.31 per second for a call from B to C at peak time while service operator D only charges NT$ 0.25 per second for the same call.

It is common that one service operator offers cheaper prices for one destination, while the other service operator offers cheaper prices for the other destinations. Continuing the above example, service operator A charges NT$ 0.34 per second for a call from B to E at peak time while service operator D charges more at NT$ 0.55 per second, because service operator A has a cost advantage than service operator D from B to E.

When the regulators allow separation of service operation and network operation and new technology is introduced, such as voice over IP (VOIP), there are more resellers coming in the field that offer even cheaper prices for specific destinations that these resellers have cost advantage in. Furthermore, the calling rates change over time because of price competition or technology improvement. For end customers, enterprise and consumer alike, this means confusion—the customers do not know which operators offer at this moment the best calling rates for the call he or she is going to make.

Usually, the consumer's calling behavior is difficult to change, so customers may forget to adapt his dialing behavior to take advantage of lowest calling rates offered in the market. In the example that different service operators offer international calls by different dialing prefixes, customers are often confused about which operators currently offer cheaper calling rates and hence do not know which dialing prefixes should use in making the call.

Some service operators offer customers cheaper calling rates by requiring customers to dial a predefined set of numbers in front of the dialed numbers. Some service operators require customers to install a hardware box (often called the auto-dialer) at the customer premise to route all the calls to the service operators. In both cases, the service operator may not be the one who offers the cheapest rate for the calling pattern of specific customers.

Consequently, when the customer has the freedom to make a choice upon making the call, a method and system in selecting service operator to take advantage of the lowest usage rate dynamically will be required.

### SUMMARY OF THE INVENTION

The present invention is buyer centric or customer centric, instead of seller centric. It is a method and a system that always seek the benefits for customers, similar to the role of brokers who make the best deal on behalf of customers. It sets forth a method and a system to assist customers in getting lowest usage rates. It utilizes front-end control devices at customers so that at least the front-end control devices can help customer dynamically select one service operator providing the lowest communication usage rate. The front-end control devices obtain the intelligence of routing calls dynamically by regularly exchanging information with an application service, hosted in centralized service and data centers that also provide end customers necessary service and technology support.

The following conditions are assumed in the method and the system: (1) The end customers can make a choice from more than one service operator offering the communication service when making the call; (2) At least part of the communication is priced by communication duration or traffic, such as minutes or data volume; (3) Each service operator distinguishes each other by dialing prefixes or parameters in the calling number or digital sequence that establishes the communication; and (4) The same end terminal is used to make the connection to different service operators.

The front-end control devices route calls to utilize the lowest usage rate offered by service operators by dynamically change the dialing prefixes or parameters.

The customer identification data is input to a customer service unit. The customer identification essentially comprises a serial number of the front-end control devices, customer identification number, customer name, customer phone number, customer address, estimated monthly amount, historic calls and the combinations. The entry could be done by customers themselves through interactive voice response (IVR) or by customer service representatives talking to the customers. Customers may also enter customer identification in the front-end control devices, which later transfer the data to the customer service unit.

Thereafter, the dialing data of the customer is received and then stored in the memory of the front-end control device wherein the dialing data comprises dialed numbers or parameters, calling time, calling duration, and calling traffic. Afterwards, the front-end control device periodically calls back to the customer service unit to acquire the number-mapping table optimized based upon the previous dialing data and the fixed charge and variable rates of all service operators for the communication. Specifically, the fixed charge and the variable rates are used to calculate the usage rate in the central server wherein the variable rates are related to a portion of communication, potentially classified by time, such as peak-time, off peak-time, holidays, particular-days or data volume.

In some cases, the customer has free calling minutes or data to designated calls at some time slots to some destinations wherein the free calling minutes data may be incorporated into the central server for optimization. The present invention also allows to utilize the volume discount data generated by the customer's communication traffic so that the service operator charges a percentage of the total bill to the customer wherein the volume discount data will be input into the central server for calculation.

When customers make calls, the front-end control device utilizes the dialed numbers or parameters and the number-mapping table to locally obtain dialed-out numbers or parameters corresponding to the service operator offering lowest communication usage rate.

Subsequently, the customer service records of the customer are inquired. The customer inquires customer service records of the customer from a website controlled by the central server wherein the customer is authorized by identifying the customer identification for communication security. In addition, the customer may be able to flexibly change a code name of the service operator determined by the central server into another desired service operator as default setting. The website periodically transmit customer service records, possibly by e-mail, to the customer for the purpose of customer service. In the preferred embodiment of the present invention, the customer service records essentially comprise the dialing data, dialed-out numbers or parameters, saved communication-cost for each and all calls with respect to the customer, and fixed charge and variable rates and discount plans of all service operators. The fixed charge and variable rates, and discount plans, of all service operators can be retrieved or provided automatically from the service operators.

Finally, the code name of the service operator is displayed at the display portion of the front-end control device when the call is made. The service operator provides the lowest usage rate for the call. The front-end control device can also display the advertising messages from the central server as additional revenue for the central operation.

In the present invention, a system diagram of optimizing usage rate comprises a dialing device, a front-end control device, a central server and a communication network. The dialing device makes a dialing process so that the dialing device may create a communication with the service operator.

The front-end control device is used to change one dialing prefix or parameter generated by the customer through the dialing device into another dialing prefix or parameters, as part of the actual dialed-out numbers or parameters, corresponding to the service operator that offers lowest usage rates. The dialed-out numbers or parameters actually establish the communication between the dialing device and the chosen service operator. The front-end control device also needs to communicate with the central server through wide-area network, possibly through an IP connection using one service operator. Additionally, the front-end control device may be a kind of software program incorporated into the dialing device or existing communication devices, such as network servers, PBXs, or gateway servers.

The central server, a control center having N-tiered application system architecture, comprises a customer service unit, an information management unit, an application program unit and a database unit. The customer service unit is coupled to the local network to receive inbound calls from and to make outbound calls to the customer or the front-end control device, to confirm customer identification, to provide customer service, to exchange information between the front-end control device and the central server. Moreover, the customer service maintains updated information with respect to the customer and the service operator for operation.

The information management unit is coupled to the local network for managing data stream within the central server and the local network. The application program unit, coupled to the local network, computes the communication-cost based on the service operator's fixed charge and variable rates and the customer's dialing data. In the preferred embodiment of the present invention, the fixed charge and the variable rates are based on communication duration or traffic. The database unit is coupled to the local network and the application program unit for providing the application program unit with a plurality of operation tables, e.g. customer identification, dialing data, number-mapping table, fixed charge and variable rates, discount plans, customer service records, advertising messages, service operator codes and the combinations.

### BRIEF DESCRIPTION OF THE DRAWINGS

The foregoing aspects and many of the attendant advantages of this invention will become more readily appreciated and become better understood by reference to the following detailed description, when taken in conjunction with the accompanying drawings, wherein:

FIG. 1 illustrates a flow chart of assisting customers in getting lower usage rates according to the present invention; and

FIG. 2 illustrates a system diagram of assisting customers in getting lower usage rates according to the present invention.

### DETAILED DESCRIPTION OF THE PREFERRED EMBODIMENT

The present invention is directed to a method and a system for assisting customers in getting lower usage rates to achieve the above-mentioned requirement.

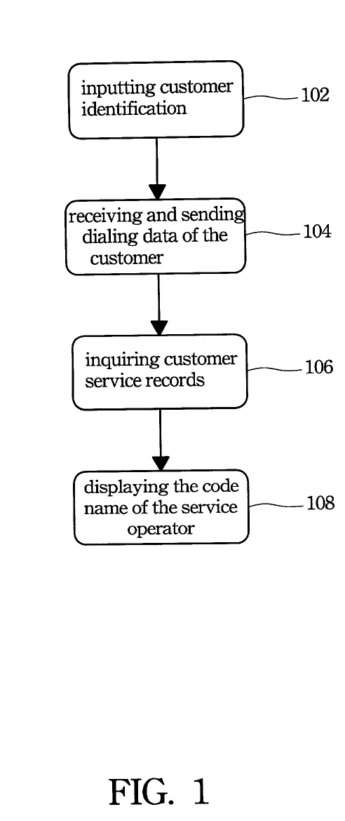

Referring to FIG. 1, this figure shows a flow chart of assisting customers in getting lower usage rates according to the present invention. A customer is able to dynamically select a service operator providing a communication service at a lower usage rate. At least part of the communication is priced by communication duration or traffic, and a dialing prefix, or part of the input and dialing parameters are used to distinguish service operators and the communication service thereof. In the preferred embodiment of the present invention, the communication service is any one of international call, long distance call, roaming, point-to-point connection, wireline, wireless, cable TV, satellite, broadcast, voice, data, broadband, multimedia communication or the combinations.

In step 102, the customer identification data is input to a customer service unit. The customer identification essentially comprises a serial number of the front-end control devices, customer identification number, customer name, customer phone number, customer address, estimated monthly amount, historic calls and the combinations. The entry could be done by customers themselves through interactive voice response (IVR) or by customer service representatives talking to the customers. Customers may also enter customer identification in the front-end control devices, which later transfer the data to the customer service unit. Thereafter, the central server would precisely calculate the communication-cost and generate a number-mapping table, e.g. international number-mapping table, for the customers.

In step 104, the dialing data of the customer is received and then stored in the memory of the front-end control device wherein the dialing data comprises dialed numbers or parameters, calling time, calling duration, and calling traffic. Thereafter, the front-end control device periodically calls back to the customer service unit to acquire the number-mapping table optimized based upon the previous dialing data and the fixed charge and variable rates of all service operators for the communication.

In the first embodiment of the present invention, the fixed charge and the variable rates are used to calculate the usage rate in the central server wherein the variable rates are related to a portion of communication, potentially classified by time, such as peak-time, off peak-time, holidays, particular-days or data volume. In addition, the dialing data in said front-end control device is regularly sent to the customer service unit and used to acquire the number-mapping table optimized based upon previous the dialing data in accordance with a fixed charge and variable rates of a plurality of service operators for communication service.

Assume there are two service operators O_1 and O_2, offering different calling rates {R_ij, R_ij>=0} for three types of destinations, D_1, D_2, and D_3 wherein i=1, 2 and j=1, 2, 3. C_1, C_2, and C_3 denote respectively the calling duration or traffic to destinations D_1, D_2, and D_3 made by the customer in a period, such as one month. {X_ij, X_ij>=0}, where i=1, 2 and j=1, 2, 3, is the individual duration or traffic that the customer would choose in using service operators O_1 and O_2 to make calls to destination D_1, D_2, and D_3, and X_11+X_21=C_1, X_12+X_22=C_2, and X_13+X_{23=C}_3 as constraints.

S_1 is the fixed charge (traffic independent) by service operator O_1, and S_2 is the fixed charge (traffic independent) by service operator O_2 in the period.

The customer, to get the lowest calling rates, would make calls, i.e., in choosing {X_ij}, such that

(S_1+X_11*R_11+X_12*R_12+X_13*R_13)+(S_2+X_21*R_21+X_22*R_22+X_23*R_23)

is minimized.

In the second embodiment of the present invention, the customer has free calling minutes or data to designated calls at some time slots to some destinations wherein the free calling minutes or data is incorporated into the central server for optimization. To choose {X_ij|i=1, 2, . . . , n; j=1, 2, . . . , k} that minimize SUMOF (SUMOF (R_ij*(X_ij-F_ij ), where i=1, 2, . . . , n)+S_i, where j=1, 2, . . . , k), {F_ij|i=1, 2, . . . , n; j=1, 2, . . . , k} are the free calling minutes or data offered by service operators O_i for destinations D_j.

The present invention also can utilize the volume discount offered by the service operators as one input to the central server. The volume discount takes part of the bill from the total bill to reward the customers that make a lot of calls.

Most importantly, when making an international call, the customer does not need to change his dialing behavior. The front-end control device would automatically update or expand the dialing prefix according to the dialing region, the dialing time, and the number-mapping table, in order to take advantage of lowest international calling rates without customer notice.

In step 106, the customer service records of the customer are inquired. The customer inquiries customer service records of the customer by entering a website controlled by the central server wherein the customer is authorized by identifying the customer identification for communication security. In addition, the customer may be able to flexibly change a code name of the service operator determined by the central server into another desired service operator as default setting. The website may periodically transmit customer service records, such as e-mail, to the customer for the purpose of customer service. In the preferred embodiment of the present invention, the customer service records essentially comprise the dialing data, dialed-out numbers or parameters, the saved communication-cost for each and all calls with respect to the customer, and fixed charge and variable rates and discount plans of all service operators and the current calling rate.

In step 108, the code name of the service operator is displayed at the display portion of the front-end control device when the call is made, such as liquid crystal display (LCD). The front-end control device can also displays the advertising messages from the central server as additional revenue for the central operation.

As long as some portion of the communication services are priced by traffic, the present invention can be applied to all traffic types, including voice or data, offered and by the network technologies of the service operators. Furthermore, more than one service operator offers the communication service to the customers in view of the same communication service. Each service operator distinguishes each other by dialing prefixes or parameters in the calling number or digital code that establishes the communication service.

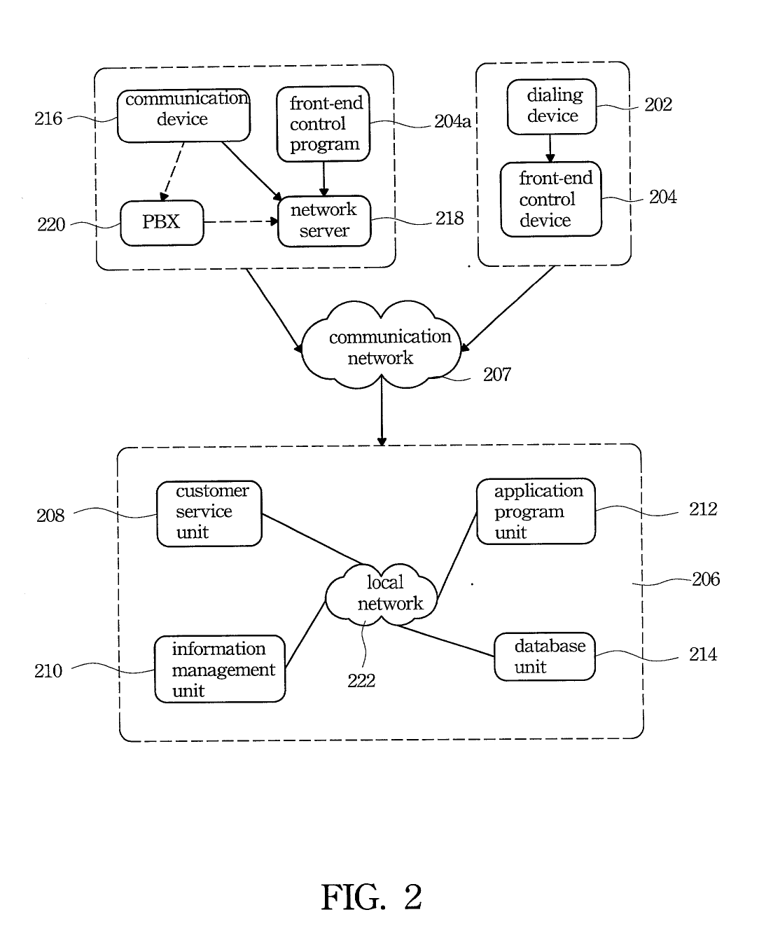

Referring to FIG. 2, this figure shows a system diagram of optimizing communication-cost according to the present invention. The system diagram comprises a dialing device 202, a front-end control device 204, a central server 206 and a communication network 207 wherein the central server 206 comprises a customer service unit 208, an information management unit 210, a application program unit 212 and a database unit 214.

The dialing device 202 makes a dialing process so that the dialing device 202, e.g., phones, fax machines, computers, private exchange (PBX) 220, mobile phones, data gateways, data switches, personal data assistant (PDA), gaming devices, television, setup boxes, and the combinations, may create a communication with the service operator. In addition, the dialing device 202, as an end terminal, initiate and use the communication service provided by the service operators through the front-end control device 204 to the communication network 207 using the communication protocol of the communication services.

The front-end control device 204 is coupled to the dialing device 202 to change one dialing prefix or parameter generated by the customer through the dialing device 202 into another dialing prefix or parameters, as part of the actual dialed-out numbers or parameters, corresponding to the service operator that offers lowest usage rates. The dialed-out numbers or parameters actually establish the communication between the dialing device 202 and the chosen service operator. The front-end control device 204 also needs to communicate with the central server 206 through wide-area network, possibly through an IP connection using one service operator. Additionally, the front-end control device 204 may be a kind of software program 204a incorporated into the dialing device 202 or existing communication devices 216, such as network servers 218, PBX 220, or gateway servers.

The existing communication device 216 includes telephones, personal computer (PC), cellular phones, auto-dialer, answering machines, PBXs, information displayers, modems, data gateways, data switches, setup boxes, multi-service access devices (integrating voice, data, fax, etc.). When the same end terminal supports more than one communication service, all services can be all applied by the same method and system, For example, customers selectively use the same phone/PBX 220 to dial international and long distance service. The communication network 207, e.g. Internet, is coupled to the front-end control device 204 for information transmission among a variety of network devices.

The central server 206, a control center, is coupled to the front-end control device 204 via a communication network 207 connected to a local network 222 for internal communication. Basic operation and management reports will be provided to facilitate service operation. The central server 206 figures best-rate information from the rate tables and customer's calling data. The front-end control device 204 then retrieves updated, necessary, but minimum, information from the central server 206 so that the front-end control device 204 can perform the best-rate intelligence. Afterwards, the front-end control device 204 removes the historic records, to save memory usage, and disconnects the connection with the central server 206. The central server 206 can also use data warehousing techniques to segment customers and perform database marketing for displaying advertising messages from the customer service unit 208.

The customer service unit 208 is coupled to the local network 222 to receive inbound calls from and to make outbound calls to the customer or the front-end control device 204, to confirm customer identification, to provide customer service, to exchange information between the front-end control device 204 and the central server.206. Moreover, the customer service unit 208 maintains updated information with respect to the customer and the service operator for operation.

The information management unit 210 is coupled to the local network 222 for managing data stream within the central server 206 and the local network 222.

The application program unit 212, coupled to the local network 222, computes the communication-cost based on the service operator's fixed charge and variable rates and the customer's dialing data. In the preferred embodiment of the present invention, the fixed charge and the variable rates based on communication duration or traffic.

The database unit 214 is coupled to the local network 222 and the application program unit 212 for providing the application program unit 212 with a plurality of operation tables, e.g. customer identification, dialing data, number-mapping table, fixed charge and variable rates, discount plans, customer service records, advertising messages, service operator codes and the combinations.

The central server 206 would connect directly to all service operators to receive updated rate table. Relationship between the service operator promotion programs, change of fixed charge and variable rates s, and increase of customer usage can be tracked and analyzed by the central server. The central servers may act as a message broadcast or advertising agent. Messages and advertisements may be sent from the central server 206 to the front-end control device 204 and shown in the display section of the front-end control device 204.

In some case, parameter configuration substitutes dialing prefixes for some communication services to distinguish service operators. For international calls, dialing prefixes are often used to distinguish different operators in making a call. In most data communication, the same end terminal, e.g. PC, PDA, setup box, or mobile phone, is used to transmit data across different operators by using parameter configuration, e.g. software, subscriber identity module (SIM) card and database, to decide which service operator to be used in carrying the data traffic.

In summary, the present invention provide a method and a system for at least assisting customers to get the lowest usage rates when establishing the connection, if the end customers can make a choice from more than one service operator when making the call by the same communication device or end terminal. Each service operator distinguishes each other by dialing prefixes or parameters in the calling number or digital sequence that establishes the communication. At least part of the communication is priced by communication duration or traffic, such as minutes or data volume.

As understood by a person skilled in the art, the foregoing preferred embodiments of the present invention are illustrations rather than limitations of the present invention. It is intended to cover various modifications and similar arrangements included within the spirit and scope of the appended claims, the scope of which should be accorded the broadest interpretation so as to encompass all such modifications and similar structure.

What is claimed is:

1. A method to at least dynamically assist a customer to use a service operator that offers a lowest usage rate, where at least a portion of communication service is charged by duration, said method comprising the steps of:
inputting customer identification to a customer service unit such that said customer service unit confirms with the customer after said customer identification is exactly received;
receiving dialing data of the customer, storing said dialing data in the memory of a front-end control device, and then making a call based on a number-mapping table in said front-end control device;
sending said dialing data in said front-end control device regularly to said customer service unit and acquiring said number-mapping table optimized based upon previous said dialing data in accordance with a fixed charge and variable rates of a plurality of service operators for said communication;
inquiring customer service records of the customer from a website controlled by said central server wherein the customer is authorized by identifying said customer identification for communication security; and
displaying the code name of said service operator to correctly show said service operator providing lowest usage rate when said call is made.

2. The method of claim 1, wherein said communication service is the one selected from one group consisting of international call, long distance call, roaming call, and point-to-point connection call, wireline, wireless, cable TV, satellite, broadcast, voice, data, broadband, multimedia communication and the combinations.

3. The method of claim 1, wherein said customer identification is the one selected from one group consisting of the serial number of said front-end control devices, customer identification number, customer name, customer phone number, customer address, historic calls and the combinations.

4. The method of claim 1, wherein said dialing data is the one selected from one group consisting of dialed numbers, dialed parameters, calling time, calling duration, calling traffic, and the combinations.

5. The method of claim 4, wherein said front-end control device utilizes said dialed numbers, said dialed parameters and said number-mapping table to obtain a plurality of dialed-out parameters corresponding to said service operator offering lowest communication usage rate.

6. The method of claim 1, further using said dialing data, said fixed charge and variable rates of all service operators, and a plurality of discount plans of said service operators to map out a plurality of dialed-out parameters to utilize the lowest communication usage rate.

7. The method of claim 6, wherein said fixed charge, variable rates, and said discount plans of said service operators can be retrieved automatically from said service operators.

8. The method of claim 1, further comprising the step that the customer is able to change said code name of said service operator determined by said central server into another desired service operator as default setting.

9. The method of claim 1, wherein said website may periodically send said customer service records to e-mail box of the customer to reduce customer query on the website.

10. The method of claim 1, wherein said customer service records are the one selected one group consisting of said dialing data, dialed-out parameters, saved communication-cost, said fixed charge, said variable rates, discount plans and the combinations.

11. A system to at least dynamically assist a customer to use a service operator that offers a lowest communication usage rate, wherein at least a portion of communication service is charged by duration, said system comprising:
a dialing device for making a dialing process to create a communication with said service operator;
a front-end control device, coupled to said dialing device, for transferring one dialing parameter generated by the customer into another dialing parameter corresponding to said service operator, for storing a dialing data, and for regularly exchanging information; and
a central server, coupled to said front-end control device via a communication network connected to a local network for internal communication, said central server having:
an application program unit, coupled to said local network, for computing the communication-cost by using dialing data in accordance with fixed charge and variable rates of a plurality of service operators for said communication service; and
a database unit, coupled to said local network and said application program unit, for providing said application program unit with a plurality of operation tables.

12. The system of claim 11, wherein said communication service is the one selected from one group consisting of international call, long distance call, roaming call, point-to-point connection call, wireline, wireless, cable TV, satellite, broadcast, voice, data, broadband, multimedia communication and the combinations.

13. The system of claim 11, wherein said dialing device is the one selected from one group consisting of phones, fax machines, computers, private exchange (PBX), mobile phones, data gateways, data switches, personal data assistant (PDA), gaming devices, television, setup boxes, and the combinations.

14. The system of claim 11, wherein said front-end control device is at least a software program incorporated into the dialing device.

15. The system of claim 11, wherein said central server utilize data warehousing techniques to segment customers and perform database marketing for displaying advertising messages from said customer service unit.

16. The system of claim 11, further comprising a customer service unit coupled to said local network for maintaining information with respect to the customer and said service operator.

17. The system of claim 11, further comprising an information management unit coupled to said local network for managing data stream within said central server and said local network.

18. The system of claim 11, further using free calling minutes and volume discount plans offered by said service operator to optimize the communication-cost.

19. The system of claim 11, wherein said operation tables is the one selected from one group consisting of a customer identification, said dialing data, a number-mapping table, said fixed charge, said variable rates, a discount plans, a customer service records, a advertising messages, service operator codes and the combinations.

20. A system to at least dynamically assist a customer to use a service operator that offers a lowest communication usage rate, where at least a portion of communication service is charged by duration, said system comprising:
a dialing device for making a dialing process to create a communication with said service operator;
a front-end control device, coupled to said dialing device, for transferring one dialing parameter generated by the customer into another dialing parameter corresponding to said service operator, for storing a dialing data, and for regularly exchanging information; and
a central server, coupled to said front-end control device via a wide-area communication network connected to a local network for internal communication, said central server having:
a customer service unit, coupled to said local network, for maintaining information with respect to the customer and said service operator;
an information management unit, coupled to said local network, for managing data stream within said central server and said local network;
an application program unit, coupled to said local network, for computing the communication-cost by using dialing data in accordance with fixed charge and variable rates of a plurality of service operators for said communication service; and
a database unit, coupled to said local network and said application program unit, for providing said application program unit with a customer identification, said dialing data, a number-mapping table, said fixed charge, said variable rates, a discount plans, a customer service records, a advertising messages, service operator codes and the combinations.
